(19) United States
(12) Patent Application Publication
(10) Pub. No.: US 2025/0332055 A1
(43) Pub. Date: Oct. 30, 2025

(54) BRAKE STRUCTURE OF ROLLATOR AND ROLLATOR

(71) Applicant: Zijie Liu, Zhongshan (CN)

(72) Inventor: Zijie Liu, Zhongshan (CN)

(21) Appl. No.: 18/757,745

(22) Filed: Jun. 28, 2024

(30) Foreign Application Priority Data
Apr. 29, 2024 (CN) 202420928213.X

(51) Int. Cl. A61H 3/04; F16C 1/12; F16D 49/00; F16D 65/28; F16D 121/14

(52) U.S. Cl. CPC A61H 3/04; F16C 1/12; F16D 49/00; F16D 65/28; A61H 2003/046; A61H 2201/1635; F16D 2121/14

(57) ABSTRACT

A braking structure of a rollator and a rollator are provided, the barking structure includes an internally hollow handlebar, the handlebar is provided with an insertion port, the insertion port is movably provided with a brake handle connected to a brake cable, and further includes a first positioning pin penetrating on the handlebar and connected to one end of the brake handle located within the insertion port; a brake component, a middle of the brake component is connected to one end of the brake handle near the insertion port and connected to the brake cable; a second positioning pin penetrating on the handlebar and connected to one end of the brake component away from the brake cable. The brake handlebar can drive the brake component to rotate around the second positioning pin.

### CROSS-REFERENCE TO RELATED APPLICATIONS

This application claims priority to Chinese Patent Application No. 202420928213X, filed on Apr. 29, 2024, which is hereby incorporated by reference in its entirety.

### TECHNICAL FIELD

The present disclosure relates to the field of rollator technologies, and in particular, to a brake structure of a rollator and a rollator.

### BACKGROUND

Rollator is an auxiliary tool for people with limited mobility, typically used to provide stable support and balance while walking. The existing rollators usually add additional braking structures on the casters, which require manual stepping to achieve parking and braking. However, a few rollators can achieve parking braking and cadence braking through handbrake. The assembly is more complex and there are many parts, especially when pressing down on the brake, which is not smooth enough. People with limited mobility find it difficult to press down on the handbrake to achieve parking braking. Therefore, there is an urgent need for a simple assembly, fewer parts, and labor-saving brake structure.

### SUMMARY

The present application aims to solve the above-mentioned technical problems by providing a simple assembly, fewer parts, and labor-saving bark structure of a rollator and a rollator.

A brake structure of a rollator, including:
an internally hollow handlebar, where the handlebar is provided with an insertion port, the insertion port is movably provided with a brake handle connected to a brake cable;
a first positioning pin, which penetrates the handlebar and is connected to one end of the brake handler located within the insertion port;
a brake component, where a middle of the brake component is connected to one end of the brake handle close to the insertion port and connected to the brake cable;
a second positioning pin, which penetrates the handlebar and is connected to one end of the brake component away from the brake cable; the brake handler is capable of driving the brake component to rotate around the second positioning pin;
when the brake handle moves in a direction close to the handlebar, the brake component is driven to rotate around the second positioning pin to brake; when the brake handle moves in a direction away from the handlebar, the brake component rotates around the second positioning pin to brake.

In an embodiment of the present disclosure, brake handle includes a handle portion and a connection portion that is far away from the handle portion and penetrates the insertion port, where the connection portion is provided with a sliding hole; the first positioning pin penetrates the sliding hole and is fixed to the handlebar; when the handle portion moves in the direction away from the handlebar, the sliding hole rotates with the connection portion, and the first positioning pin is placed on an inner wall of the sliding hole and lift the brake component to rotate around the second positioning pin to brake.

In an embodiment of the present disclosure, the sliding hole includes a starting position, a parking position, and a braking position along a motion direction; when the first positioning pin is located at the starting position, the braking structure is in a free state;
when the brake handle moves in the direction away from the handlebar, the starting position of the first positioning pin is transited to the parking position, and the brake component rotates around the second positioning pin with the brake handle to park and brake;
when the brake handle moves in the direction close to the handlebar, the starting position of the first positioning pin is transited to the braking position, and the brake component rotates around the second positioning pin with the brake handle to park the brake.

In an embodiment of the present disclosure, the sliding hole is a triangular shaped sliding hole, and the starting position, parking position, and braking position are respectively located at ends of three corners of the triangular shaped sliding hole; the end of the parking position is further provided with a limit groove facing forward, and the first positioning pin is capable of matching and clamping with the limit groove to maintain the parking and braking.

In an embodiment of the present disclosure, a lower of the brake handle is further provided with a guide groove configured for the brake component to move.

In an embodiment of the present disclosure, brake handle is provided with a connection hole, the connection hole is further provided with a connection shaft; the brake component is hinged to the brake handle through the connection shaft.

In an embodiment of the present disclosure, the brake component includes a fixed portion configured to fix the brake cable, a first hinged portion located at one end of the brake component away from the fixed portion and hinged with the second positioning pin, and a second hinged portion located in a middle of the brake component and hinged with the connection shaft.

In an embodiment of the present disclosure, a lower of the fixed portion is provided with a wire groove configured to connect the brake cable.

A new rollator, including the brake structure of a rollator, further includes a wheel, and a brake block, where one end of the brake block abuts against a peripheral side of the wheel and the other end of the brake block is connected to a brake cable; when the brake handle moves in a direction close to the handlebar, the brake component is capable of driving the brake block connected to the brake cable to abut against the wheel so as to brake the wheel.

Compared with existing technology, the beneficial effects of the present application are as follows:
the present application provides a brake structure of a rollator. By providing with a first positioning pin and a second positioning pin, the brake handle can drive the brake component to rotate around the second positioning pin to achieve braking function. When the brake handle moves in a direction towards handlebar, the brake component rotates around the second positioning pin to brake; when the brake handle moves in a direction away from the handlebar, the brake component will also rotate around the second positioning pin to brake. This design is simple and effective, which can achieve bidirectional braking function, improve the convenience and safety of the rollator, and provide a user with a more stable and reliable braking experience. At the same time, the design of this structure makes the brake handle be tightly connected to the brake cable, reducing braking delay, enhancing braking sensitivity, simple assembly, fewer parts, and labor-saving in a braking process, effectively improving the overall performance and user experience of the rollator.

### BRIEF DESCRIPTION OF DRAWINGS

In order to provide a clearer explanation of the technical solution in the embodiments of the present application, a brief introduction will be given below to the accompanying drawings required in the description of the embodiments.

FIG. 1 is a three-dimensional schematic diagram of an assembly of a brake structure of a rollator in the present application.

FIG. 2 is an exploded view of the brake structure of a rollator in the present application.

FIG. 3 is a cross-sectional view of a free state of the brake structure of a rollator in the present application.

FIG. 4 is a sectional view of a cadence braking of the brake structure of a rollator in the present application.

FIG. 5 is a sectional view of a parking state of the brake structure of a rollator in the present application.

FIG. 6 is a three-dimensional schematic diagram of a rollator in the present application.

### DESCRIPTION OF EMBODIMENTS

The following is a further explanation of the present disclosure in combination with the accompanying drawings:

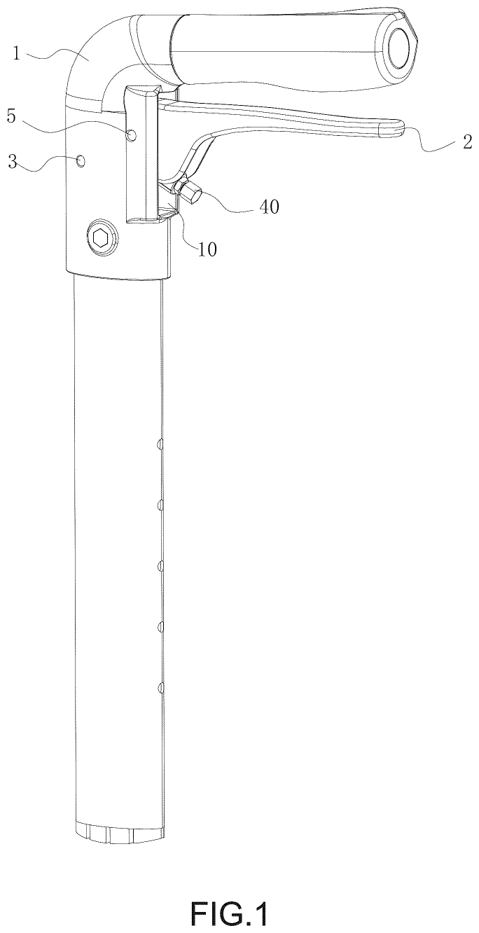

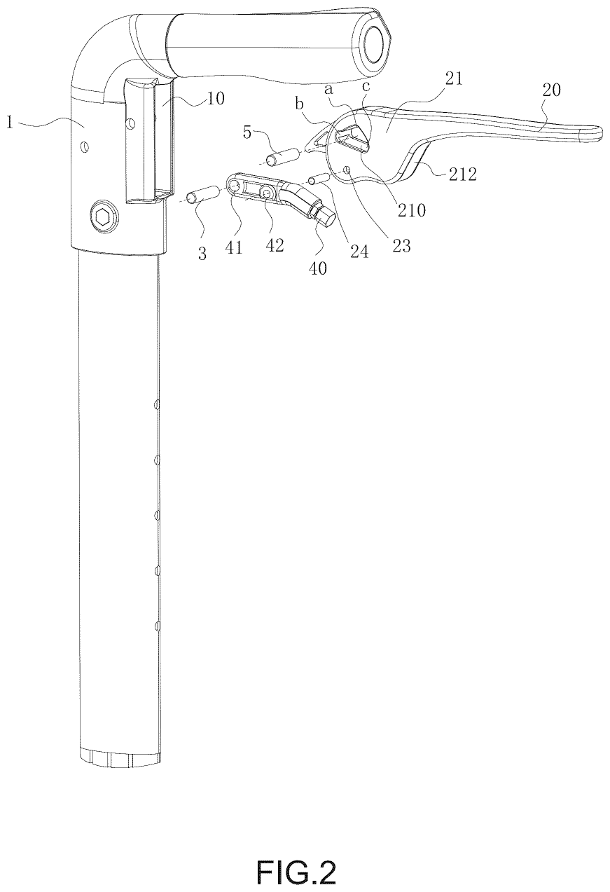

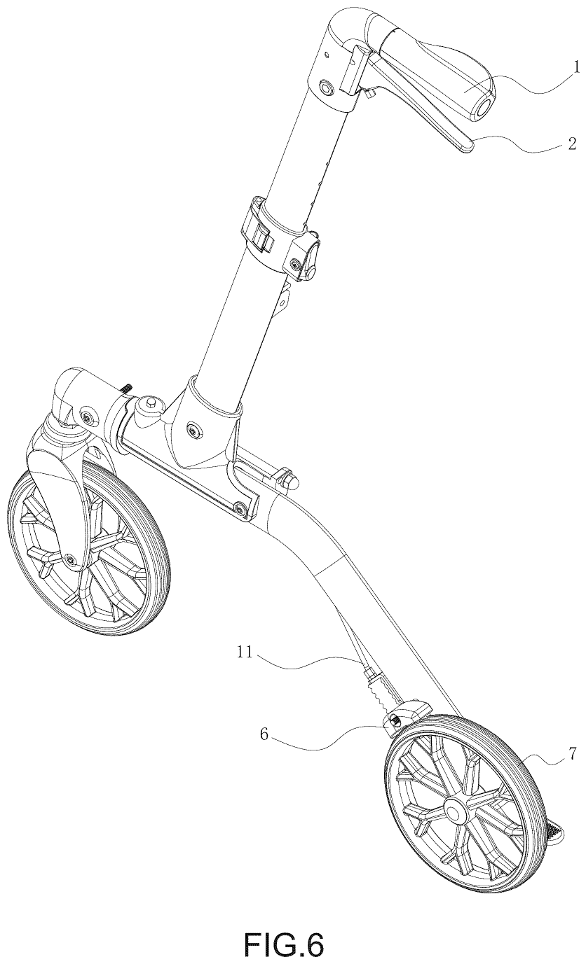

As shown in FIGS. 1-6, a brake structure of a rollator includes a handlebar 1, an insertion port 10, a brake handle 2, a brake cable 11, a first positioning pin 3, a brake component 4, a second positioning pin 5, a sliding hole 210, a connection portion 21, a first hinged portion 41, a second hinged portion 42, a starting position a, a parking position b, and a braking position c.

The brake structure of a rollator includes the internally hollow handlebar 1, where the handlebar 1 is provided with the insertion port 10, the insertion port 10 is movably provided with the brake handle 2 connected to the brake cable 11, and further includes a first positioning pin 3 that penetrates the handlebar 1 and is connected to one end of the brake handle 2 located within the insertion port 10; a brake component 4, where a middle of the brake component 4 is connected to one end of the brake handle 2 close to the insertion port 10 and connected to the brake cable 11; a second positioning pin 5 that penetrates the handlebar 1 and is connected to one end of the brake component 4 away from the brake cable 11. The brake handle 2 can drive the brake component 4 to rotate around the second positioning pin 5.

When the brake handle 2 moves in a direction close to the handlebar 1, the brake component 4 is driven to rotate around the second positioning pin 5 to brake. When the brake handlebar 2 moves in a direction away from the handlebar 1, the brake component 4 rotates around the second positioning pin 5 to brake. By providing with the first positioning pin and the second positioning pin, the brake handlebar can drive the brake component to rotate around the second positioning pin to achieve the braking function. When the handlebar moves in the direction toward the handlebar, the brake component rotates around the second positioning pin to brake; when the handlebar moves in the direction away from the handlebar, the brake component will also rotate around the second positioning pin to brake. This design is simple and effective, which can achieve bidirectional braking function, improve the convenience and safety of a rollator, and provide a user with a more stable and reliable braking experience. At the same time, the design of this structure renders the brake handle and brake cable to be connected tightly, reduces braking delay, enhances braking sensitivity, is easy to assemble, has fewer parts, and the braking process is labor-saving, effectively improving the overall performance and user experience of the rollator.

In an implementation, the brake handle 2 includes a handle portion 20 and a connection portion 21 that is far away from the handle portion 20 and penetrates into the insertion port 10. The connection portion 21 is provided with a sliding hole 210, the first positioning pin 3 penetrates the sliding hole 210 and fixed to the handlebar 1. When the handle portion 20 moves in a direction away from the handlebar 1, the sliding hole 210 rotates with the connection portion 21. The positioning pin 3 is placed on an inner wall of the sliding hole 210 and lifts the brake component 4 to rotate around the second positioning pin 5 to brake. The user only needs to simply move the handle portion 20 so as to achieve braking. Meanwhile, through a design of the sliding hole 210 and the positioning pin 3, the brake component 4 can be stably controlled, ensuring the accuracy and stability of braking. An overall structure is simple and effective, improving the braking performance and operational convenience of the rollator, providing the user with a safer and more reliable user experience.

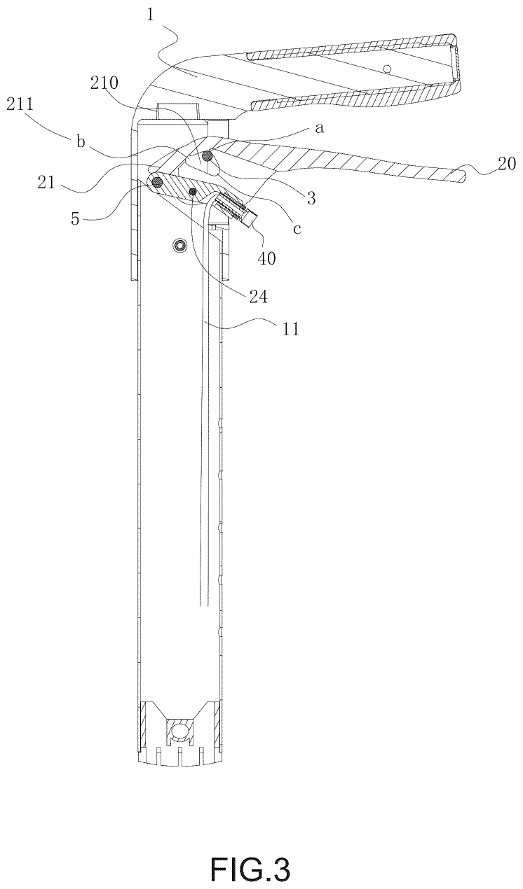

In an implementation, as shown in FIG. 3, the sliding hole 210 includes a starting position a, a parking position b, and a braking position c along a motion direction. When the first positioning pin 3 is located at the starting position a, the braking structure is in a free state.

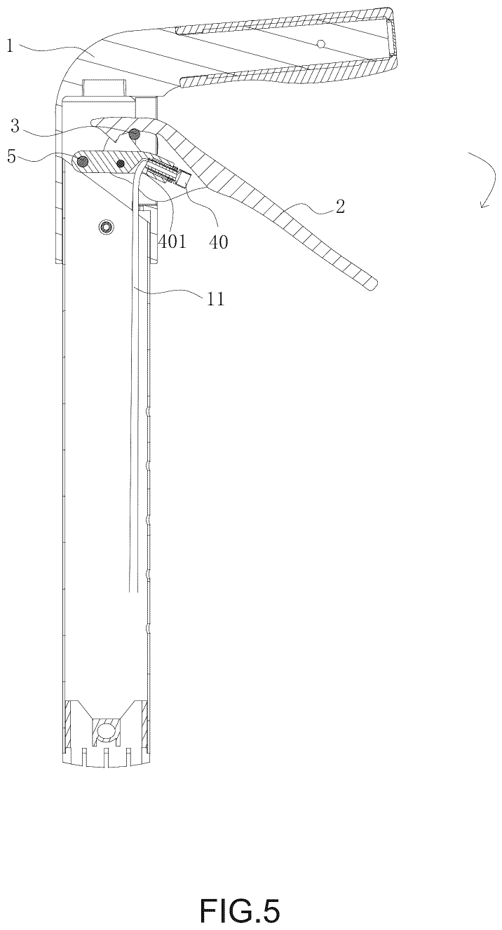

As shown in FIG. 5, when the brake handle 2 moves in the direction away from the handlebar 1, the starting position a of the first positioning pin 3 is transited to the parking position b. The brake component 4 rotates around the second positioning pin 5 with the brake handle 2 to parking and braking.

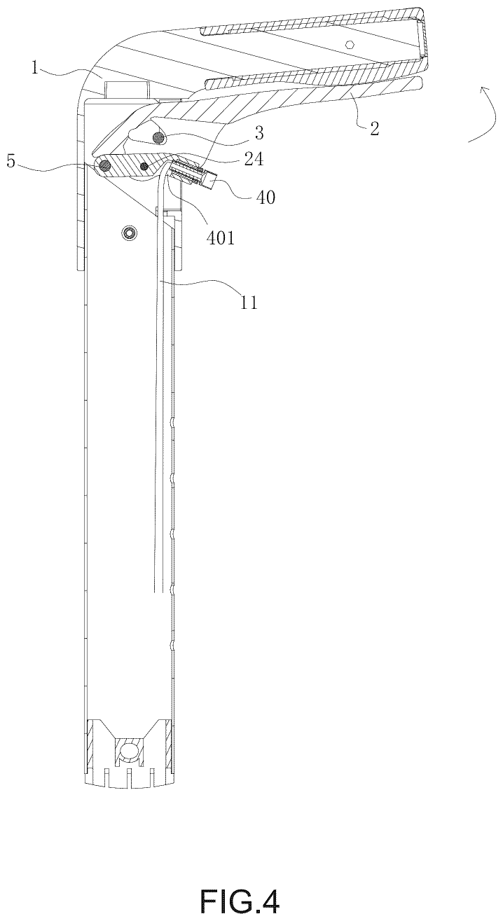

As shown in FIG. 4, when the brake handle 2 moves in the direction close to the handlebar 1, the starting position a of the first positioning pin 3 is transited to the braking position c. The brake component 4 rotates around the second positioning pin 5 with the brake handle 2 to preform cadence braking, improving the braking flexibility and applicability of the rollator in different situations. The user can choose an appropriate braking method according to needs, which increases the convenience and safety of driving operations. At the same time, through the setting of the sliding hole 210 and the position conversion of the first positioning pin 3, the brake component 4 can be stably controlled, ensuring the accuracy and stability of braking, and providing the user with a more reliable and safe driving experience.

In an implementation, the sliding hole 210 is a triangular shaped sliding hole, and the starting point position a, parking position b, and braking position c are located at ends of three corners of the triangular shaped sliding hole, respectively. The end of the parking position b is further provided with a limit groove 211 facing forward. The first positioning pin 3 can be matched and clamped with the limit groove 211 to maintain the parking and braking. The first positioning pin 3 can obtain additional limit support at the parking position b, ensuring the stability and reliability of the braking system in the parking state. The setting of the limit groove 211 can effectively prevent the brake component 4 from accidentally detaching or moving during parking, improving the entire safety and reliability of the brake system, through a cooperation with the limit groove 211, the first positioning pin 3 can be firmly fixed in the parking position b, effectively maintaining stable braking of the vehicle in the parked state, providing the user with a safer and more reliable user experience.

In an implementation, a lower of the brake handle 2 is further provided with a guide groove 212 configured for the brake component 4 to move.

In an implementation, the brake handle 2 is provided with a connection hole 23, and the connection hole 23 is provided with a connection shaft 24. The brake component 4 is hinged to the brake handle 2 through the connection shaft 24. By providing with the connection shaft 24, a stable connection is formed between the brake handle 2 and the brake component 4, rendering the braking operation more intuitive and flexible. The user can control the movement of brake component 4 by operating brake handle 2, achieving precise control of the brake system. When in the braking state, a distance between the connection shaft 24 and the first positioning pin 3 remains unchanged. When transitioning from the free state to the parking state, the brake handle will use the connection shaft as a fulcrum to lift the brake component.

In an implementation, the brake component 4 includes a fixed portion 40 configured to fix the brake cable 11, a first hinged portion 41 located at one end of the brake component 4 away from the fixed portion 40 and is capable of being hinged with the second positioning pin 5, and a second hinged portion 42 located in a middle of the brake component 4 and is capable of being hinged with the connection shaft 24.

In an implementation, a lower of the fixed portion 40 is provided with a wire groove 401 configured to connect the brake cable 11.

A rollator, including the brake structure of a rollator as described, further including a wheel 7, and a brake block 6 that can abut against a peripheral side of the wheel 7 at one end and be connected to the brake cable 11 at the other end. When the brake handle 2 moves in the direction close to the handlebar 1, the brake component 4 can drive the brake block 6 connected to the brake cable 11 to abut against the wheel 7 so as to cause the wheel 7 to be braking, and the same applies when in the parking state.

The above is only preferred embodiments of the present disclosure and is not intended to limit it. Any modifications, equivalent replacements, and improvements made within the spirit and principles of the present disclosure should be included within the protection scope of the present disclosure.

What is claimed is:

1. A brake structure of a rollator, comprising:
an internally hollow handlebar, wherein the handlebar is provided with an insertion port, the insertion port is movably provided with a brake handle connected to a brake cable;
a first positioning pin, which penetrates the handlebar and is connected to one end of the brake handler located within the insertion port;
a brake component, where a middle of the brake component is connected to one end of the brake handle close to the insertion port and connected to the brake cable;
a second positioning pin, which penetrates the handlebar and is connected to one end of the brake component away from the brake cable; the brake handler is capable of driving the brake component to rotate around the second positioning pin;
when the brake handle moves in a direction close to the handlebar, the brake component is driven to rotate around the second positioning pin to brake; when the brake handle moves in a direction away from the handlebar, the brake component rotates around the second positioning pin to brake.

2. The brake structure of a rollator according to claim 1, wherein the brake handle comprises a handle portion and a connection portion that is far away from the handle portion and penetrates the insertion port, wherein the connection portion is provided with a sliding hole; the first positioning pin penetrates the sliding hole and is fixed to the handlebar; when the handle portion moves in the direction away from the handlebar, the sliding hole rotates with the connection portion, and the first positioning pin is placed on an inner wall of the sliding hole and lift the brake component to rotate around the second positioning pin to brake.

3. The brake structure of a rollator according to claim 2, wherein the sliding hole comprises a starting position, a parking position, and a braking position along a motion direction; when the first positioning pin is located at the starting position, the braking structure is in a free state;
when the brake handle moves in the direction away from the handlebar, the starting position of the first positioning pin is transited to the parking position, and the brake component rotates around the second positioning pin with the brake handle to park and brake;
when the brake handle moves in the direction close to the handlebar, the starting position of the first positioning pin is transited to the braking position, and the brake component rotates around the second positioning pin with the brake handle to park the brake.

4. The brake structure of a rollator according to claim 3, wherein the sliding hole is a triangular shaped sliding hole, and the starting position, parking position, and braking position are respectively located at ends of three corners of the triangular shaped sliding hole; the end of the parking position is further provided with a limit groove facing forward, and the first positioning pin is capable of matching and clamping with the limit groove to maintain the parking and braking.

5. The brake structure of a rollator according to claim 1, wherein a lower of the brake handle is further provided with a guide groove configured for the brake component to move.

6. The brake structure of a rollator according to claim 1, wherein the brake handle is provided with a connection hole, the connection hole is further provided with a connection shaft; the brake component is hinged to the brake handle through the connection shaft.

7. The brake structure of a rollator according to claim 6, wherein the brake component comprises a fixed portion configured to fix the brake cable, a first hinged portion located at one end of the brake component away from the fixed portion and hinged with the second positioning pin, and a second hinged portion located in a middle of the brake component and hinged with the connection shaft.

8. The brake structure of a rollator according to claim 7, wherein a lower of the fixed portion is provided with a wire groove configured to connect the brake cable.

9. A rollator, comprising the brake structure of a rollator according to claim 1, further comprises a wheel, and a brake block, wherein one end of the brake block abuts against a peripheral side of the wheel and the other end of the brake block is connected to a brake cable; when the brake handle moves in a direction close to the handlebar, the brake component is capable of driving the brake block connected to the brake cable so as to abut against the wheel to brake the wheel.
